(19) United States
(12) Patent Application Publication
(10) Pub. No.: US 2017/0010619 A1
(43) Pub. Date: Jan. 12, 2017

(54) AUTOMATION KIT FOR AN AGRICULTURAL VEHICLE

(71) Applicants: CNH Industrial America LLC, New Holland, PA (US); Autonomous Solutions, Inc., Mendon, UT (US)

(72) Inventors: Christopher A. Foster, Mohnton, PA (US); Daniel John Morwood, Petersboro, UT (US); Michael G. Hornberger, Weston, ID (US); Bret Todd Turpin, Wellsville, UT (US); Jeremy A. Harris, Preston, ID (US)

(21) Appl. No.: 15/200,840

(22) Filed: Jul. 1, 2016

Related U.S. Application Data
(60) Provisional application No. 62/190,185, filed on Jul. 8, 2015.

(51) Int. Cl. G05D 1/02; B60W 10/30; B60W 10/10; B60W 10/06; B60W 10/18; B60W 10/20

(52) U.S. Cl. CPC G05D 1/0223; B60W 10/18; B60W 10/20; B60W 10/10; B60W 10/06; B60W 10/30; G05D 1/0278; B60W 2300/158; B60W 2520/06; B60W 2710/20; B60W 2710/18; B60W 2720/24; B60W 2710/10; B60W 2710/0644; B60W 2710/30; B60Y 2200/222; G05D 2201/0201; B60W 2420/00; B60W 2420/42; B60W 2550/10; B60W 2520/10

(57) ABSTRACT

The present disclosure relates to an automation kit for an agricultural vehicle that includes a kit controller configured to receive feedback from at least one sensor, to receive a mission path, and to receive a location signal from a locating device, where the kit controller is configured to control a velocity of the agricultural vehicle based at least on the mission path, the feedback, and the location signal. The automation kit also includes a vehicle interface configured to communicatively couple the kit controller to a bus of the agricultural vehicle, where the bus is communicatively coupled to at least a brake controller configured to control a hydraulic valve of a braking system of the agricultural vehicle, and the kit controller is configured to control the velocity at least by selectively sending a signal to the brake controller to control the braking system.

### CROSS REFERENCE TO RELATED APPLICATIONS

This application claims priority from and the benefit of U.S. Provisional Patent Application No. 62/190,185, entitled “AUTOMATION KIT FOR AN AGRICULTURAL VEHICLE,” filed Jul. 8, 2015, which is hereby incorporated by reference in its entirety.

### BACKGROUND

The present application relates generally to autonomous agricultural systems, and more specifically, to an automation kit for an agricultural vehicle.

Operating an agricultural vehicle with a manual operator may lead to increased costs, less production, and decreased efficiency. For example, in addition to the costs of paying an operator, the operator or driver may follow a path having more turns and/or fewer straight segments. Accordingly, costs may increase because it may take the operator a substantial amount of time to cover a desired area (e.g., a field). Additionally, the agricultural vehicle may consume more energy (e.g., fuel) over that time further increasing costs. In other words, costs increase and production and efficiency decrease the longer it takes an operator to perform a mission using the agricultural vehicle.

### BRIEF DESCRIPTION

The present disclosure relates to an automation kit for an agricultural vehicle that includes a kit controller configured to receive feedback from at least one sensor, to receive a mission path, and to receive a location signal from a locating device, where the kit controller is configured to control a velocity of the agricultural vehicle based at least on the mission path, the feedback, and the location signal. The automation kit also includes a vehicle interface configured to communicatively couple the kit controller to a bus of the agricultural vehicle, where the bus is communicatively coupled to at least a brake controller configured to control a hydraulic valve of a braking system of the agricultural vehicle, and the kit controller is configured to control the velocity at least by selectively sending a signal to the brake controller to control the braking system.

The present disclosure also relates to an automation kit for an agricultural vehicle that includes a kit controller configured to receive feedback from at least one sensor, to receive a mission path, and to receive a location signal from a locating device, where the kit controller is configured to control a velocity of the agricultural vehicle based at least on the mission path, the feedback, and the location signal. The automation kit also includes a vehicle interface configured to communicatively couple the kit controller to a bus of the agricultural vehicle, where the bus is communicatively coupled to at least a steering controller configured to control a direction of the agricultural vehicle, and the kit controller is configured to control the velocity at least by selectively sending a signal to the steering controller.

The present disclosure also relates to a vehicle automation system for an agricultural vehicle that includes a kit controller configured to receive feedback from at least one sensor, to receive a mission path, and to receive a location signal from a locating device. The kit controller is configured to control a velocity of the agricultural vehicle based at least on the mission path, the feedback, and the location signal, and the kit controller is configured to control the velocity of the agricultural vehicle by selectively sending a first signal to a braking control system and by selectively sending a second signal to a steering control system.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an embodiment of an agricultural implement and a work vehicle, in accordance with an aspect of the present disclosure;

FIG. 2 is a block diagram of an embodiment of an automation kit communicatively coupled to a platform system of the work vehicle of FIG. 1 via a vehicle bus, in accordance with an aspect of the present disclosure;

FIG. 3 is a perspective view of an embodiment of the automation kit of FIG. 2, in accordance with an aspect of the present disclosure;

FIG. 4 is a block diagram of an architecture of the automation kit of FIG. 2 communicatively coupled to the platform system of FIG. 2, in accordance with an aspect of the present disclosure; and

FIG. 5 is a block diagram of a velocity/powertrain control system of the automation kit of FIG. 2, in accordance with an aspect of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

Operating a non-autonomous agricultural vehicle (referred to as “work vehicle” herein), such as tractors, harvesters, sprayers, and the like, in terrains (e.g., fields) may lead to higher costs, less production, and decreased efficiency, as compared to an autonomous (e.g., automated) vehicle. For example, autonomous vehicles may include functions (e.g., programmable software) that enable the agricultural vehicle to work in a specified terrain (e.g., a field) and follow a desired path (e.g., mission path), which may lead to decreased energy consumption (e.g., gas consumption) and increased productivity and efficiency. In other words, autonomous vehicles may be programmed to perform at a level that a typical operator or driver may not achieve. For example, an operator or a driver may be unaware of an effective route for covering an area, and thus, the operator or driver may follow a path having more turns and/or fewer straight segments than the more effective route. Accordingly, it may take the operator more time and energy (e.g., fuel) to cover the desired area than it may take an automated work vehicle following the more effective route.

Generally, autonomous vehicles follow a specified path, which is predetermined by an automated system (e.g., with input from an operator), to conduct a specified function such as tillage, fertilizing, planting, spraying, harvesting, mowing, baling, and/or planting operations. For example, the operator may specify a desired mission, and the automated system may establish a mission path through an agricultural field, e.g., using a global navigation satellite system (GNSS) to guide the vehicle through the agricultural field. Further, the autonomous vehicle may adjust the mission path to enhance operability and/or increase productivity (e.g., adjustments made as a result of bump detection, velocity control, and/or position optimization). However, in certain instances, an agricultural vehicle may be purchased without autonomous features. Therefore, it may be desirable for an owner of a non-autonomous agricultural vehicle to purchase a single unit (e.g., an automation kit) that may be installed via a vehicle bus of the non-autonomous agricultural vehicle to provide such vehicle with autonomous capabilities.

The embodiments described herein relate to an automation kit that may be integrated into a non-autonomous agricultural vehicle to enable the agricultural vehicle to operate without an operator manually controlling vehicle operations. For example, the automation kit may be configured to direct the vehicle along a set path (e.g., mission path) to complete a mission (e.g., harvest, mow, or spray) in an agricultural field. Moreover, the automation kit may be configured to automatically adjust a velocity (e.g., speed and/or direction) and/or a mission path of the vehicle based on environmental factors such as bumps and/or other obstacles in the field. For example, the automation kit may receive feedback from one or more sensors that monitor conditions (e.g., bumps, holes, humans, animals) in the agricultural field such that the mission path and/or the velocity (e.g., speed and/or direction) of the vehicle may be adjusted accordingly (e.g., the vehicle may stop or slow down if an animal or human is positioned along the path). Additionally, the automation kit may determine the mission path such that the vehicle covers an entire area of the field along an efficient route (e.g., a route having a reduced distance and/or fewer turns). The automation kit may be directly integrated into a non-autonomous agricultural vehicle to convert such vehicle into a fully-automated or semi-automated vehicle. Accordingly, an operator may not be physically present in the vehicle, but may monitor vehicle operation from a remote location.

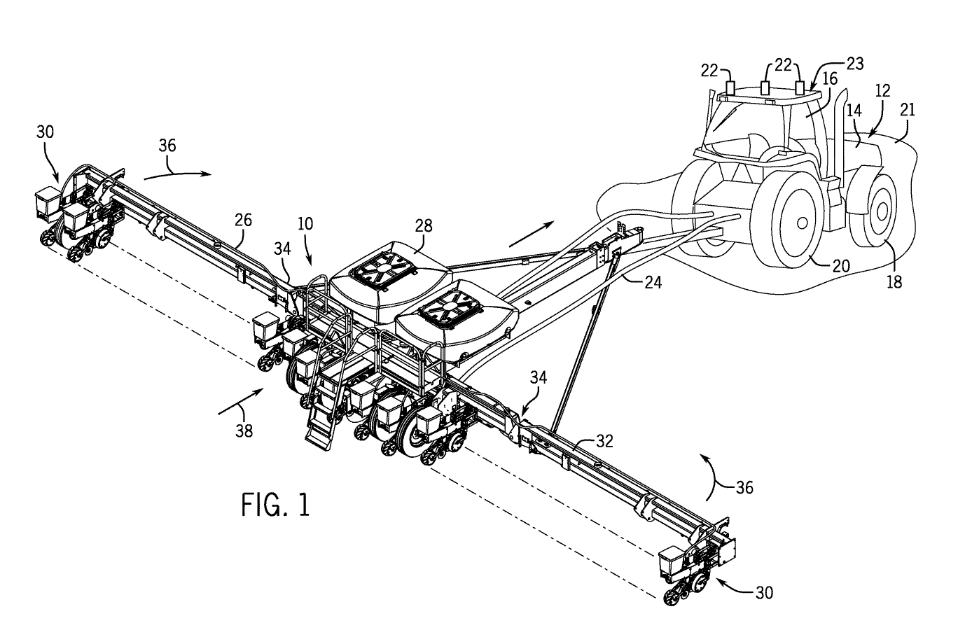

Turning now to the drawings, FIG. 1 is a perspective view of an embodiment of an agricultural implement 10 and a work vehicle 12 (e.g., agricultural vehicle or tractor). In certain embodiments, the work vehicle 12 receives operating instructions from a controller of an automated kit. The illustrated work vehicle 12 has a body 14 that houses an engine, transmission (e.g., gear box), braking system, steering system, a four-wheel drive (4WD)/differential lock system, power train, or a combination thereof. The work vehicle 12 has a cabin 16 where an operator may sit or stand to manually operate the vehicle 12 when the automated kit is disabled. The work vehicle 12 has two front wheels 18 and two rear wheels 20 that rotate to move the work vehicle 12 along the ground 21 (e.g., a field) at a ground speed (e.g., velocity). In some embodiments, the work vehicle 12 may have tracks rather than one or both sets of wheels 18, 20.

As shown in the illustrated embodiment of FIG. 1, the work vehicle 12 includes sensors 22 that may be utilized to monitor conditions of the ground 21 (e.g., a field). For example, the sensors 22 are mounted on a roof 23 of the work vehicle 12 such that the sensors 22 may be free from obstruction caused by other components of the work vehicle 12 (e.g., a frame of the cabin 16 or windows of the work vehicle). However, the sensors 22 may be positioned in any suitable location on the work vehicle 12 such that the sensors 22 may accurately monitor and provide feedback regarding the surrounding environment of the work vehicle 12. In certain embodiments, the sensors 22 may include light detecting and ranging (LIDAR) sensors, radio detection and ranging (RADAR) sensors, stereo-vision sensors, cameras (e.g., video cameras), 3-dimensional time of flight sensors, bumper sensors, infrared cameras (e.g., infrared video cameras), or any combination thereof. In other embodiments, the sensors 22 may include any type of sensor configured to monitor conditions of the environment surrounding the work vehicle 12 and provide feedback to the automation kit.

The sensors 22 are configured to send feedback to a controller of the automation kit that may then perform operations based on such feedback. For example, the controller may include a sub-system that may perform simultaneous location and mapping (SLAM), obstacle detection, object recognition, contextual reasoning, and/or another form of decision making. As a non-limiting example, a LIDAR sensor may detect an object along the ground 21 and send feedback to the controller regarding how far the object is from the work vehicle 12. Accordingly, another sub-system of the controller may adjust a mission path and/or a velocity (e.g., speed and/or direction) of the work vehicle 12 to avoid a collision or other undesirable contact with the object.

In addition to automating the work vehicle 12, the automation kit may also automate the agricultural implement 10 by instructing the agricultural implement 10 to activate and/or deactivate at certain points along the mission path, for example. The agricultural implement 10 is towed behind the work vehicle 12 across the ground 21, as shown in FIG. 1. However, in certain embodiments, the agricultural implement 10 may be a self-contained, self-propelled machine (e.g., a self-propelled sprayer, a combine harvester, a forage harvester, etc.). In such embodiments where the agricultural implement 10 is a self-contained, self-propelled machine, the automation kit may communicatively couple to the agricultural implement 10 directly. While the illustrated embodiment includes a planter, it should be appreciated that the agricultural implement 10 may be a field cultivator, sprayer, or any other type of agricultural implement towed behind the work vehicle 12. The work vehicle 12 supplies a working fluid (e.g., hydraulic fluid) to the agricultural implement 10 via one or more fluid lines 24. One or more actuators (e.g., hydraulic motors, hydraulic cylinders, etc.) receive the working fluid from the work vehicle 12 and drive systems of the agricultural implement 10. For example, one or more hydraulic motors may drive a fan and/or seed drive to direct agricultural material (e.g., seeds, fertilizer, etc.) along supply lines 26 from tanks 28 to multiple row units 30 distributed along a frame assembly 32. Each row unit 30 may be configured to deposit seeds at a desired depth beneath the soil surface, thereby establishing rows of planted seeds.

The agricultural implement 10 may have a variety of systems driven by the working fluid (e.g., hydraulic fluid) supplied by the work vehicle 12. For example, motors of the agricultural implement 10 may be driven by the working fluid to facilitate delivery of the agricultural product and/or may establish a vacuum pressure within the tanks 28 or supply lines. In some embodiments, the frame assembly 32 of the agricultural implement 10 may be adjustable to fold into a transport configuration (e.g., via rotation of wings about joints 34) as shown by arrows 36 to align the frame assembly 32 with a direction of travel 38. Accordingly, the automation kit may adjust the frame assembly 32 by controlling a valve on the work vehicle 12 that is fluidly coupled with the lines 24. In embodiments where the automation kit is communicatively coupled to the agricultural implement 10 directly, the automation kit may adjust the frame assembly 32 by sending signals to a controller via a bus on the agricultural implement 10.

In some embodiments, the work vehicle 12 includes a vehicle bus. The vehicle bus may be a communications network (e.g., wireless or wired) that enables components of the work vehicle 12 to communicate and/or otherwise interact with one another. For example, the vehicle bus of the work vehicle 12 may include a controller area network (CAN) bus. The CAN bus may enable individual control systems (e.g., the engine control system, the transmission control system, the braking control system, the steering/guidance control system, and/or the 4WD/differential lock control system) of the work vehicle 12 to communicate with one another and with a kit controller. In certain embodiments the kit controller may include one or more processors and one or more memory components. More specifically, the one or more processors may include one or more application specific integrated circuits (ASICs), one or more field programmable gate arrays (FPGAs), one or more general purpose processors, or any combination thereof. Additionally, the one or more memory components may include volatile memory, such as random access memory (RAM), and/or non-volatile memory, such as read-only memory (ROM), optical drives, hard disc drives, or solid-state drives.

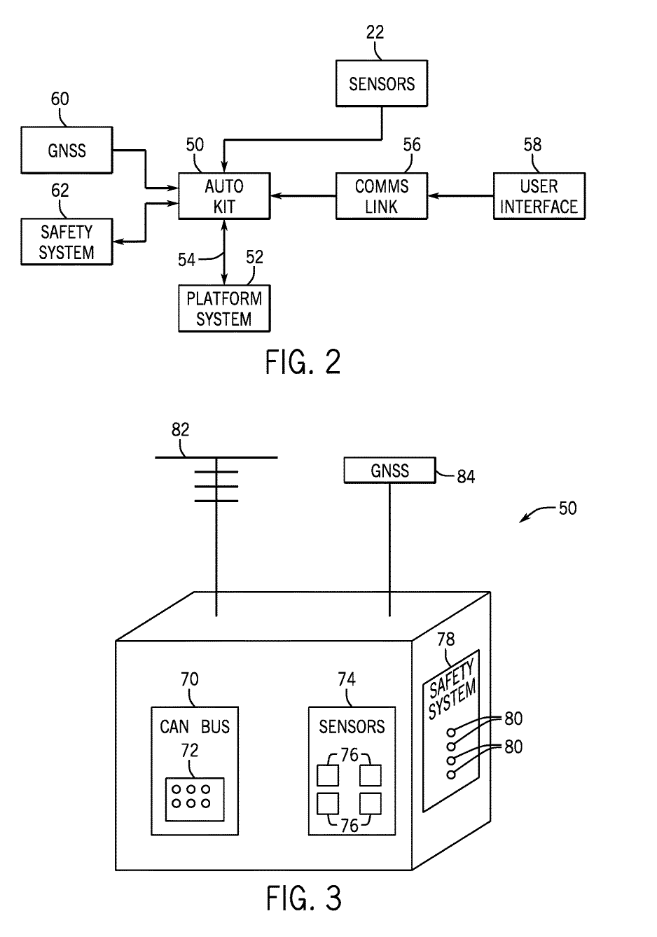

In certain embodiments, the automation kit may be communicatively coupled to a platform system of the work vehicle 12 via the vehicle bus (e.g., CAN bus). For example, FIG. 2 is a block diagram of an embodiment of an automation kit 50 communicatively coupled to a platform system 52 of the work vehicle 12 via the vehicle bus 54 (e.g., CAN bus). In certain embodiments, the automation kit 50 may include one or more controllers and an interface such that it may be connected to the platform system 52 via the CAN bus 54. Additionally, the one or more controllers of the automation kit 50 may include processors (e.g., ASICs, FPGAs, general purpose processors, or a combination thereof) and memory components (e.g., RAM, ROM, optical drives, hard disc drives, solid-state drives) such that the automation kit 50 may perform various functions and control (e.g., automate) operations of the work vehicle 12.

As shown in the illustrated embodiment of FIG. 2, the automation kit 50 may receive inputs from various components of the work vehicle 12 and/or other external devices separate from the work vehicle 12. As discussed above, the work vehicle 12 may include one or more sensors 22 that may monitor a surrounding environment of the work vehicle 12 and provide feedback regarding obstacles and/or other conditions pertaining to the environment surrounding the work vehicle 12. Accordingly, the sensors 22 may send feedback (e.g., signals) to the automation kit 50, which may then utilize such feedback to adjust a mission path and/or velocity (e.g., speed and/or direction) of the work vehicle 12. Adjustments made by the automation kit 50 in response to the feedback from the sensors 22 may direct the work vehicle 12 around obstacles and/or optimize performance of the work vehicle 12.

Additionally, the automation kit 50 may receive feedback (e.g., signals) from a communications link 56, which in turn, may receive user input data from a user interface 58. For example, an operator may input a desired mission (e.g., mowing or harvesting a specific field) for the work vehicle 12 to perform via a keyboard and/or touch screen of the user interface 58. The user interface 58 may relay a desired mission path to the communications link 56, which may then send a signal containing the mission path (e.g., via a wireless or wired connection) to the automation kit 50. In certain embodiments, the automation kit 50 may include an antenna or another form of receiver configured to receive the signal from the communications link 56. Additionally, the communications link 56 may receive real-time video feedback from a camera or other audio-visual device mounted on the work vehicle 12. Accordingly, an operator may monitor and/or make adjustments to the mission path of the work vehicle 12 based on visual feedback from the camera. In other embodiments, the mission path may be received by the automation kit 50 from any other suitable source.

Further, in the illustrated embodiment of FIG. 2, the automation kit 50 receives feedback from a locating device (e.g., a global navigation satellite system 60 (GNSS)). The GNSS 60 (e.g., a global positioning system (GPS)) may be mounted to the work vehicle 12 and configured to send real-time data to the automation kit 50 regarding a location (e.g., geographical coordinates) of the work vehicle 12. Therefore, the automation kit 50 may utilize such location data to control the velocity (e.g., speed and/or direction) of the work vehicle 12 such that the work vehicle follows the mission path, and/or to make adjustments to the mission path of the work vehicle 12.

Additionally, the automation kit 50 may send and receive signals (e.g., feedback) from a safety system 62. The safety system may include such features as a forward/neutral/reverse/park (FNRP) system, an engine ignition switch, an emergency brake, an auto/manual switch (e.g., a switch completely disabling the automation kit 50 and enabling manual operation of the work vehicle 12), beacons, a horn, and any combination thereof. Therefore, the automation kit 50 may be configured to receive signals from the safety system 62 when such features are activated, disengaged, and/or inoperable. For example, when the emergency brake is activated, the safety system 62 may alert the automation kit 50 such that the automation kit 50 does not instruct the work vehicle 12 to move along the mission path while the emergency brake is engaged. Additionally, the automation kit 50 may receive a signal from the auto/manual switch that activates and/or deactivates the automation kit 50. For example, the automation kit 50 may be entirely or partially deactivated when the auto/manual switch is turned to a manual position. Conversely, the automation kit 50 may be fully activated when the auto/manual switch is turned to an auto position.

The automation kit 50 may also send signals to the safety system 62 to engage and/or disengage the safety features. For example, when the automation kit 50 determines that the work vehicle 12 should move along the mission path, the automation kit 50 may send a signal to the safety system 62 to instruct the safety system 62 to disengage the emergency brake such that the work vehicle 12 may move without incurring resistance from the emergency brake.

Additionally, the automation kit 50 is configured to send and/or receive signals from the platform system 52 of the work vehicle 12. In certain embodiments, the platform system 52 may include an engine control system, a transmission control system, a braking control system, a steering/guidance control system, a 4WD/differential lock control system, an auxiliary control system, or any combination thereof. Such systems of the platform system 52 may be interconnected via the vehicle bus 54. Therefore, when the automation kit 50 is connected to the vehicle bus 54, the automation kit 50 may communicate with the platform system 52, thereby enabling the automation kit 50 to communicate with and control the systems of the work vehicle 12. For example, the automation kit 50 may send signals to controllers of the engine control system and/or the transmission control system instructing the work vehicle 12 to move at a speed specified by the mission path. Additionally, the automation kit 50 may send signals commanding controllers of the braking control system to decrease a speed of the work vehicle 12 in response to feedback received from the sensors 22, for example.

Similarly, the platform system 52 may send feedback to the automation kit 50, which may contain data regarding work vehicle 12 operation. For example, the platform system 52 may send a signal to the automation kit 50 containing data related to a current (e.g., real time or near real time) velocity of the work vehicle 12. In certain embodiments, the automation kit 50 may respond to the current velocity of the work vehicle 12 by sending a second signal to the engine control system of the platform system 52 commanding a first actuator to adjust a throttle valve (e.g., open or close the throttle valve to increase or decrease speed of the work vehicle 12). Additionally, the second signal from the automation kit 50 may command a second actuator to adjust a hydraulic valve controlling a braking system of the work vehicle 12 (e.g., to slow down the work vehicle via the brakes). In any event, the automation kit 50 enables the work vehicle 12 to operate without an operator being physically present in the work vehicle 12.

For example, FIG. 3 is a perspective view of an embodiment of the automation kit 50. As shown in the illustrated embodiment of FIG. 3, the automation kit 50 includes a CAN bus interface 70 that enables the automation kit 50 to interface with the platform system 52. For example, the automation kit 50 may be directly coupled to the CAN bus 54 via a D-subminiature connection 72 (e.g., the automation kit 50 includes a female D-subminiature connector). In other embodiments, any suitable connection may be utilized to establish communication between the CAN bus 54 and the automation kit 50.

Additionally, the automation kit 50 includes a sensor interface 74, which enables the automation kit 50 to receive feedback from the sensors 22. For example, one or more of the sensors 22 may be connected to ports 76 in the sensor interface 74, thereby enabling the sensors 22 to electronically communicate with the automation kit 50. Accordingly, the automation kit 50 may adjust the mission path and/or the velocity (e.g., speed and/or direction) of the work vehicle 12 based on feedback from the sensors 22. In certain embodiments, the sensors 22 may be coupled to the automation kit 50 via an M12 connector (e.g., the automation kit 50 may include one or more female M12 connections). In other embodiments, any suitable connection may be utilized to establish communication between the sensors 22 and the automation kit 50.

The automation kit 50 also includes a safety system interface 78 that communicatively couples the automation kit 50 to components of the safety system 62. As discussed above, the safety system 62 may include an FNRP system, an ignition control, the emergency brake, the auto/manual switch, beacons, a horn, or any combination thereof. Each component of the safety system 62 may be coupled to the automation kit 50 via ports 80 located on the safety system interface 78. Accordingly, a two-way communication between the automation kit 50 and the safety system 62 may be established such that automation kit 50 may send signals to the safety system 62 and vice versa. In certain embodiments, the automation kit 50 may respond when a safety feature of the work vehicle 12 is enabled and/or disabled (e.g., when the emergency brake is engaged). For example, the safety system 62 may transmit a signal to the automation kit 50 to stop the mission path when the emergency brake of the work vehicle 12 is engaged. Similarly, the safety system 62 may transmit a second signal to the automation kit 50 to start/resume the mission path when the emergency brake of the work vehicle 12 is disengaged.

As shown in the illustrated embodiment of FIG. 3, the automation kit 50 also includes an antenna 82 and a GNSS receiver 84. In certain embodiments, the antenna 82 may be configured to receive data (e.g., signals) from the communications link 56 related to the mission path for the work vehicle 12. For example, an operator may input a desired operation for the work vehicle 12 to perform (e.g., mow a field, harvest a field, or spray a field with a specified material) as well as a location for the desired operation to be performed (e.g., a specific field, area, or coordinates) into the user interface 58. The input from the operator may be transferred to the communications link 56, which may be configured to transmit a wireless signal to the automation kit 50. The automation kit 50 may then receive the signal via the antenna 82. Further, the antenna 82 may transmit the data received to a processor or another control system of the automation kit 50 such that the automation kit 50 may respond accordingly. In certain embodiments, the antenna 82 may transmit video from a video feedback system to an operator such that the operator may monitor operation of the work vehicle 12.

The GNSS receiver 84 may be configured to receive a signal transmitted by the GNSS 60. In certain embodiments, the signal from the GNSS 60 may contain data regarding an actual (e.g., real time or near real time) position of the work vehicle 12. Such data may be transmitted to a processor or control system of the automation kit 50 for comparison to the location and/or area specified by the mission path. For example, the GNSS 60 may send geographical coordinates to the automation kit 50 such that the automation kit 50 may compare such coordinates with coordinates and/or a location specified by the mission path. Additionally, the signal from the GNSS may correspond to a velocity (e.g., speed and/or direction) of the work vehicle 12, which the automation kit 50 may compare to a velocity specified by the mission path. Accordingly, the automation kit 50 may control the velocity (e.g., speed and/or direction) of the work vehicle 12 so that the work vehicle 12 moves along the mission path. In other embodiments, the automation kit 50 may not include the receiver 84. For example, the antenna 82 may be configured to receive signals from both the communications link 56 and the GNSS 60.

As discussed above, the automation kit 50 may convert a non-autonomous agricultural vehicle to an autonomous and. or automated agricultural vehicle that may function without an operator being physically present. In order to convert the non-autonomous agricultural vehicle to an automated agricultural vehicle, the automation kit 50 may include architecture that enables the automation kit 50 to interact and communicate with control systems of the work vehicle 12.

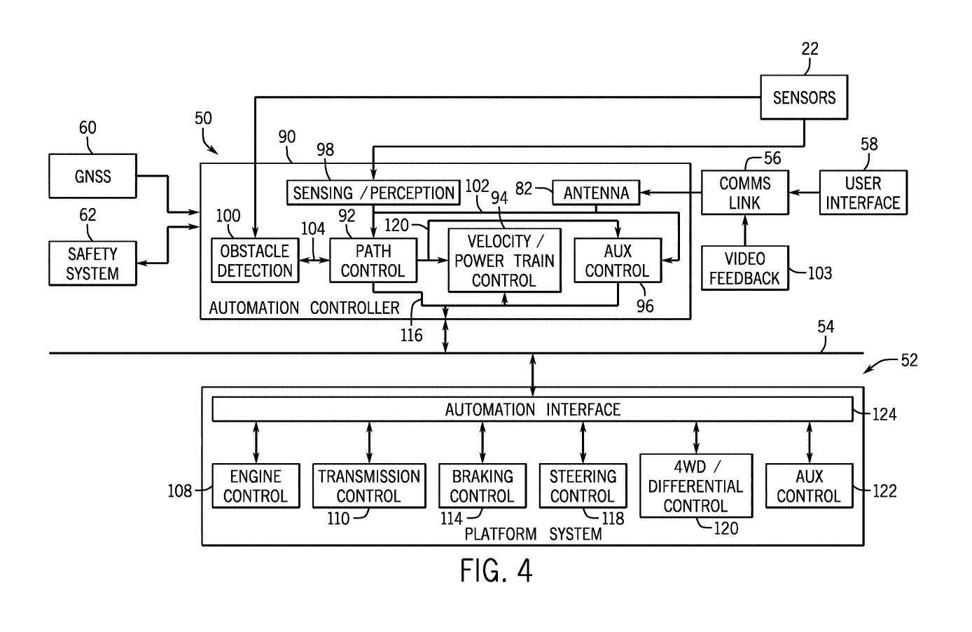

For example, FIG. 4 is a block diagram of an architecture of the automation kit 50 communicatively coupled to the platform system 52 of the work vehicle 12 via the bus 54. In certain embodiments, the automation kit 50 includes a controller 90 that includes sub-control systems that perform specific functions. For example, the controller 90 may include a path control system 92, a velocity/powertrain control system 94, an auxiliary control system 96, a sensing and perception system 98, an obstacle detection control system 100, or any combination thereof.

The path control system 92 may determine a path (e.g., the mission path) that the work vehicle 12 may follow to perform the desired mission specified by the operator. For example, the mission path of the work vehicle 12 may depend on what mission (e.g., function) the work vehicle 12 may perform (e.g., a path to mow a field may be different than a path for harvesting a field). Accordingly, the path control system 92 may receive a signal 102 from the communications link 56 (e.g., via the antenna 82) that includes data related to a mission path corresponding to the mission specified by the operator at the user interface 58. In the illustrated embodiment of FIG. 4, a video feedback system 103 is communicatively coupled to the communications link 56 and enables the operator to monitor operations of the work vehicle 12 from a remote location.

In certain embodiments, the mission path may be enhanced by the automation kit 50 such that the work vehicle 12 may carry out the mission efficiently. For example, the sensors 22 may transmit feedback to the sensing and perception system 98 related to conditions of the location (e.g., field) in which the mission of the work vehicle 12 is conducted. The sensing and perception system 98 may perform simultaneous location and mapping (SLAM) to create a real-time map of the ground 21 and/or environment proximate to the work vehicle 12. The generated map may be transmitted to the path control system 92 to enable the path control system 92 to revise and/or enhance the mission path (e.g., received by the user interface 58) based on features detected and appearing on the map. Additionally, the generated map may be stored in memory of the controller 90 such that the automation kit 50 may store environmental details of a given field, and thus, utilize the revised and/or enhanced mission path for that field during subsequent operations. For example, the next time that the work vehicle 12 performs a mission for that specified field, the automation kit 50 may utilize the stored mission path.

The sensing and perception system 98 may also perform decision making, contextual reasoning, obstacle detection, object recognition, or any combination thereof. Such functions of the sensing and perception system 98 may enable the automation kit 50 to further store details of a given location (e.g., a field) and enhance a mission path for that location.

The obstacle detection control system 100 may also utilize feedback from the sensors 22 to adjust the mission path received by the path control system 92 from the communications link 56. For example, sensors 22 may detect an obstacle along the mission path of the work vehicle 12 such as a bump, a large rock, a human, an animal, or another obstacle. The sensors 22 may transmit feedback to the obstacle detection control system 100, which may be configured to determine whether an obstacle has been detected and/or whether the mission path may be altered. When the obstacle detection control system 100 determines that the mission path is to be altered, the obstacle detection control system 100 may send a signal 104 to the path control system 92, instructing the path control system 92 to adjust the mission path to avoid the detected obstacle.

In certain cases, there may not be sufficient time for the path control system 92 to adjust the mission path upon receipt of the signal 104 sent from the obstacle detection control system 100. Accordingly, the path control system 92 may send a subsequent signal to the velocity/powertrain control system 94 corresponding to a desired velocity of the work vehicle 12. Therefore, when there is insufficient time to adjust the mission path and avoid the obstacle, the path control system 92 may instruct the velocity/powertrain control system 94 to decrease a velocity of the work vehicle 12 and/or to completely stop the work vehicle 12 to avoid contact with the obstacle. Additionally, in some cases the obstacle detection system 100 may send a signal instruction the velocity/powertrain control system 94 to adjust the velocity of the work vehicle 12 to avoid an obstacle (e.g., temporarily slow down or move in a certain direction). Accordingly, the path control system 92 may send a signal to the velocity/powertrain control system 94 instructing the velocity/powertrain control system 94 to adjust a velocity (e.g., speed and/or direction) of the work vehicle 12 to reach a velocity specified by the mission path once the obstacle has been passed (e.g., avoided).

The path control system 92 may also send a signal to the velocity/powertrain control system 94 when an increase in velocity of the work vehicle 12 is desired. For example, when performing the desired mission, the work vehicle 12 may undergo a series of turns and straight segments. It may be desirable for the work vehicle 12 to have a slower velocity when making a turn and a faster velocity when undergoing a straight segment. Therefore, the path control system 92 may send the signal to the velocity/powertrain control system 94 to adjust the velocity of the work vehicle 12 as the work vehicle 12 moves along the mission path (or the adjusted mission path).

In certain embodiments, the velocity/powertrain control system 94 adjusts the velocity of the work vehicle 12 by transmitting signals to an engine control system 108 and/or a transmission control system 110 of the platform system 52. For example, the velocity of the work vehicle 12 may be increased by sending a signal to the engine control system 108 of the platform system 52 to increase a speed of the engine (e.g., measured by revolutions per minute (RPM)). The velocity of the work vehicle 12 may also be increased by sending a signal to the transmission control system 110 of the platform system 52, instructing the transmission control system 110 to shift to a higher gear (e.g., the work vehicle 12 travels faster when operating in a higher gear). In certain embodiments, the work vehicle 12 may be completely stopped (e.g., a velocity of zero) by applying the emergency brake once the transmission control system 110 has shifted to first gear, for example. In other embodiments, the velocity of the work vehicle 12 may be increased or decreased by instructing the transmission control system 110 to change between a setting of the FNRP system (e.g.,. forward, neutral, reverse, and/or park). Changing between settings of the FNRP system may also enable the work vehicle 12 to change directions (e.g., when switching from forward to reverse or vice versa).

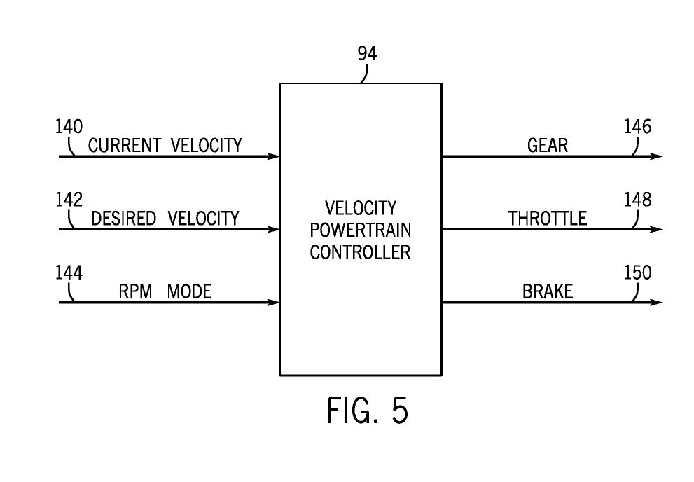

In other embodiments, the velocity/powertrain control system 94 may adjust the velocity of the work vehicle 12 by transmitting signals to a braking control system 114 and/or the engine control system 108. In some cases, the braking control system 114 may include a controller coupled to a hydraulic valve that is configured to apply the brakes of the work vehicle 12. Accordingly, rather than transmitting a signal to the transmission control system 110 to decrease the velocity of the work vehicle 12, the velocity/powertrain control system 94 may send a signal to the braking control system 114 to apply the brakes and decelerate the work vehicle 12. In still further embodiments, the velocity/powertrain control system 94 may be configured to transmit signals to the engine control system 108, the transmission control system 110, the braking control system 114, and/or any combination thereof. The velocity/powertrain control system 94 will be described in more detail herein with reference to FIG. 5.

In addition to sending signals to the velocity/powertrain control system 94, the path control system 92 may also send a signal 116 corresponding to a curvature command directly to the platform system 52. For example, the path control system 92 may send the curvature command signal 116 to a steering/guidance control system 118 of the platform system 52. The path control system 92 may utilize the mission path, the signals received from the sensing and perception system 98, and the signals received from the obstacle detection control system 100 to determine the curvature command signal 116. In certain embodiments, the curvature command signal 116 instructs the steering/guidance control system 118 to control a direction (e.g., a velocity) of the work vehicle 12 such that it follows the mission path. Therefore, the path control system 92 may generate the curvature command signal 116 based on the position of the work vehicle 12, the velocity of the work vehicle 12, and the mission path. For example, the mission path may include turns and curves such that the wheels 18, 20 of the work vehicle 12 are adjusted to change the direction of the work vehicle 12. Accordingly, the path control system 92 may send the curvature command signal 116 to the steering/guidance control system 118 of the platform system 52 to adjust a position of the wheels 18, 20 of the work vehicle 12 as the work vehicle 12 moves along the mission path.

In certain embodiments, work vehicle 12 may include a differential braking system. In such embodiments, the path control system 92 may be configured to change the direction (e.g., velocity) of the work vehicle 12 by sending a signal to the braking control system 114 to control one or more brakes of the differential braking system. Accordingly, the direction (e.g., velocity) of the work vehicle 12 may be adjusted so that the work vehicle 12 moves along the mission path.

In certain embodiments, the path control system 92 may send a signal to a 4WD/differential lock control system 120. For example, when the obstacle detection control system 100 determines that an obstacle (e.g., soft soil) is positioned along the mission path, and the work vehicle 12 cannot avoid such obstacle, the path control system 92 may send a signal to activate the 4WD/differential lock control system 120. Accordingly, the work vehicle 12 may be enabled to traverse the obstacle (e.g., soft soil) because all four wheels 18, 20 may be used to drive the work vehicle 12. In other embodiments, the path control system 92 may send a signal actuating the 4WD/differential lock control system 120 when the sensors 22 and/or a map generated by the simultaneous location and mapping function of the sensing and perception system 98 detects a steep incline in the environment surrounding the work vehicle 12.

Additionally, the path control system 92 may send a signal 120 to the auxiliary control system 96. The mission path may include various points or stretches where it may be desirable to control certain functions of the agricultural implement 10. Accordingly, the path control system 92 may instruct the auxiliary control system 96 to control various functions of the agricultural implement 10 along the mission path. The auxiliary control system 96 may be configured to send a signal to a variety of controllers included in the platform system 52 of the work vehicle 12 (or a separate platform system of the agricultural implement 10 itself) to control (e.g., activative and/or deactivate) a variety of functions of the agricultural implement 10. As a non-limiting example, when the work vehicle 12 is a tractor, the auxiliary control system 96 may be configured to control an electro-hydraulic remote (e.g., rear and/or mid-mount), a power take-off switch (e.g., rear and/or front), or a combination thereof. In certain embodiments, the auxiliary control system 96 may control a position of the agricultural implement 10 via a 3-point hitch. Additionally, the devices that the auxiliary control system 96 may control may be different when the work vehicle 12 is a harvester.

The platform system 52 may include a variety of auxiliary control systems 122, which may actuate valves, motors, or other devices configured to operate a function of the agricultural implement 10. For example, when the work vehicle 12 is a tractor, the auxiliary control systems 122 may include an electronic hydraulic remote (EHR) controller, a power take-off controller, or any combination thereof. Conversely, when the work vehicle is a harvester, the auxiliary control systems 122 may include a threshing/cleaning controller, a header/feeder controller, a header height controller, a rotor speed controller, a concave opening controller, a spreader speed controller, a fan speed controller, a sieve opening controller, an unload tube swing controller, an unload tube controller, or any combination thereof.

In certain embodiments, communications between the automation kit 50 and the platform system 52 (e.g., via the bus 54) may be monitored by an indexing heartbeat signal. For example, the platform system 52 may include an automation interface controller 124. The automation interface controller 124 may receive communications from the automation kit 50 before transmitting such signals to other control systems of the platform system 52. In certain embodiments, the automation interface controller 124 may send a heartbeat signal at regular intervals from the platform system 52 to the automation kit 50 to determine a reliability and strength of the connection between the automation kit 50 and the platform system 52. When the heartbeat signal is not received and/or delayed, the automation kit 50 may instruct the platform system 52 to bring the work vehicle 12 to a safe state (e.g., shut down the work vehicle 12). In other embodiments, the automation interface controller 124 of the platform system 52 may be configured to induce the work vehicle 12 to reach the safe state upon interruption of the heartbeat signal. Accordingly, when the connection between the automation kit 50 and the platform system 52 is completely disconnected, the work vehicle 12 may still reach the safe state without receiving instruction from the automation kit 50.

Additionally, the automation kit 50 may send set-points to the various control systems of the platform system 52 based on the mission path, the signal from the GNSS 60, signals from the safety system 62, feedback from the sensors 22, or a combination thereof. In certain embodiments, the automation interface controller 124 may be configured to check a validity of the set-points to ensure that the set-points are being sent from an expected and/or verified source (e.g., the automation kit 50) and/or that the set-points are within an expected range. Accordingly, the automation interface controller 124 may prevent control systems of the platform system 52 from attempting to reach an incorrect set-point when such set-point is not verified.

Furthermore, the automation interface controller 124 of the platform system 52 may be configured to monitor controls located in the cabin 16 of the work vehicle 12 that enable manual operation of the work vehicle 12. For example, the automation interface controller 124 may be configured to perform a manual override function that disables the automation kit 50 when an operator physically engages one or more controls in the work vehicle 12. In certain embodiments, the manual override function may entirely disable the automation kit 50 until the automation kit 50 is reactivated by the operator. In other embodiments, the manual override function may partially disable the automation kit 50 (e.g., the control systems that the operator physically took over by engaging the controls in the work vehicle 12).

Additionally, the velocity/powertrain control system 94 may act as a mechanism to control the speed of the work vehicle 12. For example, FIG. 5 is a block diagram of the inputs and outputs that may be utilized to control a velocity (e.g., speed and/or direction) of the work vehicle 12. As shown in the illustrated embodiment of FIG. 5, the velocity/powertrain control system 94 receives a current speed signal 140, a desired speed signal 142, and an RPM mode signal 144. In certain embodiments, the current speed signal 140 may be transmitted to the velocity/powertrain control system 94 by the platform system 52. For example, the platform system 52 may include a speedometer or other sensor configured to detect real-time speed of the work vehicle 12. In other embodiments, the current speed signal 140 may be transmitted by the sensors 22 or the GNSS receiver 84.

The desired speed signal 142 may be transmitted by the path control system 92. For example, the path control system 92 may determine a desired speed based on a position of the work vehicle 12 along the mission path. Accordingly, when the work vehicle 12 is making a sharp turn, the desired speed of the work vehicle 12 may be less than the desired speed when the work vehicle 12 is moving in a straight line (e.g., the wheels 18, 20 are aligned with a body of the work vehicle 12).

Additionally, the RPM mode signal 144 may be transmitted by the engine control system 110 of the platform system 52. The RPM mode signal 144 may include information regarding a speed of an engine of the work vehicle 12. Therefore, the RPM mode signal 144 may indicate whether a gear shift may be performed. The velocity/powertrain controller 94 may also transmit a signal 148 to a throttle valve of the engine control system 110 and/or a signal 150 to a hydraulic valve of the braking control system 114 in response to the received signals 140, 142, and 144. For example, when the current speed signal 140 is below the desired speed signal 142, the velocity/powertrain controller 94 may send the signal 148 to open the throttle valve, thereby increasing the speed of the work vehicle 12. Similarly, when the current speed signal 140 is above the desired speed signal 142, the velocity/powertrain controller 94 may send the signal 150 to a controller of the braking control system 114. The controller may actuate the hydraulic valve, thereby decreasing the speed of the work vehicle 12. Additionally, the velocity/powertrain controller 94 may also send the signal 148 to close the throttle valve to decrease a speed of the work vehicle 12. Still further, the velocity/powertrain controller 94 may send the signal 146 to the transmission control system to either increase and/or decrease the current speed of the work vehicle 12. In any event, the signals 146, 148, and 150 may enable the velocity/powertrain controller 94 to adjust the velocity of the work vehicle 12 such that a value of the current speed signal 140 is substantially equal to a value of the desired speed signal 142.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An automation kit for an agricultural vehicle, comprising:
a kit controller configured to receive feedback from at least one sensor, to receive a mission path, and to receive a location signal from a locating device, wherein the kit controller is configured to control a velocity of the agricultural vehicle based at least on the mission path, the feedback, and the location signal; and
a vehicle interface configured to communicatively couple the kit controller to a bus of the agricultural vehicle, wherein the bus is communicatively coupled to at least a brake controller configured to control a hydraulic valve of a braking system of the agricultural vehicle, and the kit controller is configured to control the velocity at least by selectively sending a signal to the brake controller to control the braking system.

2. The automation kit of claim 1, wherein the at least one sensor comprises a light detection and ranging (LIDAR) sensor, a radio detection and ranging (RADAR) sensor, a stereo-vision sensor, a camera, a 3-dimensional time of flight sensor, a bumper sensor, or any combination thereof.

3. The automation kit of claim 1, wherein the kit controller comprises an obstacle detection control system configured to detect an obstacle along the mission path of the agricultural vehicle, and a path control system configured to adjust the velocity upon detection of the obstacle.

4. The automation kit of claim 1, wherein the kit controller comprises a velocity/powertrain control system configured to receive a measured velocity signal from the at least one sensor or from the locating device, and a desired velocity signal from a path control system, and the velocity/powertrain control system is configured to adjust the velocity of the agricultural vehicle based on the measured velocity signal and the desired velocity signal.

5. The automation kit of claim 1, wherein the kit controller comprises a sensing and perception system having a simultaneous location and mapping device configured to generate a map of an area proximate to the agricultural vehicle, and the kit controller is configured to adjust the mission path, the velocity, or a combination thereof, based on the map.

6. The automation kit of claim 1, wherein the kit controller is configured to receive signals from a safety system and to disable control of the velocity based on the signals.

7. The automation kit of claim 1, wherein the mission path is sent through a communications link, the communications link is configured to wirelessly transmit the mission path, and the kit controller is configured to receive the mission path via the communications link.

8. The automation kit of claim 1, wherein the kit controller comprises an auxiliary control system configured to output control signals to one or more features of an agricultural implement towed by the agricultural vehicle.

9. The automation kit of claim 1, wherein the agricultural vehicle is a tractor.

10. An automation kit for an agricultural vehicle, comprising:
a kit controller configured to receive feedback from at least one sensor, to receive a mission path, and to receive a location signal from a locating device, wherein the kit controller is configured to control a velocity of the agricultural vehicle based at least on the mission path, the feedback, and the location signal; and
a vehicle interface configured to communicatively couple the kit controller to a bus of the agricultural vehicle, wherein the bus is communicatively coupled to at least a steering controller configured to control a direction of the agricultural vehicle, and the kit controller is configured to control the velocity at least by selectively sending a signal to the steering controller.

11. The automation kit of claim 10, wherein the kit controller comprises an obstacle detection control system configured to detect an obstacle along the mission path of the agricultural vehicle, and a path control system configured to adjust the velocity upon detection of the obstacle.

12. The automation kit of claim 11, wherein the path control system is configured to send a curvature command signal to the steering controller to control the velocity of the agricultural vehicle.

13. The automation kit of claim 10, comprising a user interface remote from the kit controller.

14. The automation kit of claim 10, wherein the kit controller comprises an auxiliary control system configured to output control signals to one or more features of an agricultural implement towed by the agricultural vehicle.

15. The automation kit of claim 10, wherein the steering controller adjusts a position of one or more wheels of the agricultural vehicle to control the direction of the agricultural vehicle.

16. A vehicle automation system for an agricultural vehicle, comprising:
a kit controller configured to receive feedback from at least one sensor, to receive a mission path, and to receive a location signal from a locating device, wherein the kit controller is configured to control a velocity of the agricultural vehicle based at least on the mission path, the feedback, and the location signal, and the kit controller is configured to control the velocity of the agricultural vehicle by selectively sending a first signal to a braking control system and by selectively sending a second signal to a steering control system.

17. The vehicle automation system of claim 16, wherein the kit controller is configured to control the velocity of the agricultural vehicle by selectively sending a third signal to a transmission control system, and the third signal instructs the transmission control system to change gears of a transmission of the agricultural vehicle.

18. The vehicle automation of claim 17, wherein the kit controller is configured to control the velocity of the agricultural vehicle by selectively sending a fourth signal to an engine control system, and the fourth signal instructs the engine control system to adjust a speed of an engine of the agricultural vehicle.

19. The vehicle automation of claim 16, wherein the kit controller is configured to send a third signal to an auxiliary controller of the agricultural vehicle to control one or more features of an agricultural implement towed by the agricultural vehicle.

20. The vehicle automation of claim 19, wherein the agricultural implement is a harvester.
